(19) United States
(12) Patent Application Publication
(10) Pub. No.: US 2014/0041829 A1
(43) Pub. Date: Feb. 13, 2014

(54) VEHICLE AIR CONDITIONING DEVICE

(71) Applicants: Katsuji Taniguchi, Kanagawa (JP); Tomohiro Terada, Kanagawa (JP)

(72) Inventors: Katsuji Taniguchi, Kanagawa (JP); Tomohiro Terada, Kanagawa (JP)

(73) Assignee: PANASONIC CORPORATION, Osaka (JP)

(21) Appl. No.: 14/005,869

(22) PCT Filed: Mar. 27, 2012
(86) PCT No.: PCT/JP2012/002106

§ 371 Date: Sep. 18, 2013

(30) Foreign Application Priority Data
Mar. 29, 2011 (JP) 2011-072038

(51) Int. Cl. B60H 1/00

(52) U.S. Cl. CPC B60H 1/0005
USPC 165/42

(57) ABSTRACT

In a vehicle air conditioner, air in the first flow path flows sequentially through outside air intake opening (112), blower fan (102), evaporator (103), condenser (104), and the inside of vehicle, and air in the second flow path flows sequentially through inside air intake opening (116), sensible heat exchanger (101), and the outside of the vehicle. Sensible heat exchanger (101) exchanges heat between outside air introduced from outside air intake opening (112) by the suction force of blower fan (102), and inside air passing through the first flow path and the inside of vehicle and introduced in the second flow path by the blowing force of blower fan (102). Sensible heat exchanger (101) uses drain hose (201) discharging drain water created in cooling the outside air by evaporator (103) to the outside of vehicle, to discharge the inside air for which heat was exchanged to the outside of vehicle.

### TECHNICAL FIELD

The present invention relates to a vehicle air conditioning apparatus to be installed in a vehicle such as an electric vehicle, for example.

### BACKGROUND ART

Heretofore, a vehicle air conditioning apparatus has been known which reduces a heat load in temperature control inside a passenger compartment by exchanging heat between outside air taken in from the outside of the passenger compartment and inside air within the passenger compartment to make the outside air closer to the temperature and humidity inside the passenger compartment and then introducing the outside air into a duct (see, Patent Literature (hereinafter, referred to as “PTL”) 1, for example).

Specifically, driving fan causes inside air to be introduced into a duct through an inside air inlet while causing outside air to be introduced into the duct through an outside air inlet after the outside air passes through an inside and outside air heat exchanger in the vehicle air conditioning apparatus of PTL 1. Some of a mixture of the outside air and inside air introduced into the duct passes through a cooling heat exchanger in the duct and is thus cooled, and then passes through a heating heat exchanger in the duct to be increased in temperature and is then blown into the passenger compartment. Meanwhile, some of the mixture is subjected to heat exchange with outside air by the inside and outside heat exchanger, and is discharged thereafter to the outside of the passenger compartment through a mixture outlet.

### CITATION LIST

### Patent Literature

### PTL 1

### Japanese Patent Application Laid-Open No. 2000-272326

### SUMMARY OF INVENTION

### Technical Problem

PTL 1, however, has a problem in that a sufficient heat exchange amount cannot be secured because heat is exchanged between a mixture of inside air introduced through an inside air inlet and outside air introduced through an outside air inlet, and outside air. In addition, the amount of outside air in the mixture increases with an increase in the amount of outside air to be introduced, so that the heat exchange amount further decreases. Accordingly, when air conditioning is to be performed using only the outside air introduced from the outside, there arises a problem in that not only the heat exchange amount decreases but also the system can no longer serve as an air conditioning system.

It is an object of the present invention to provide a vehicle air conditioning apparatus capable of reducing power consumption of the air conditioning apparatus by sufficiently reducing a temperature difference between the outside air introduced through the outside air inlet and the inside air introduced through the inside air inlet and thereby increasing a heat exchange amount between the inside air and the outside air in the heat exchanger.

### Solution to Problem

A vehicle air conditioning apparatus according to an aspect of the present invention includes: an outside air inlet through which outside air is introduced from outside of a passenger compartment; an inside air inlet through which inside air is introduced from inside of the passenger compartment; a heat exchanger that exchanges heat between inside air introduced through the inside air inlet and outside air introduced through the outside air inlet; a blower fan that blows outside air which has been subjected to heat exchange by the heat exchanger, or outside air introduced through the outside air inlet, or inside air introduced through the inside air inlet; an evaporator that cools outside air or inside air blown by the blower fan; and a condenser that heats the outside air or inside air cooled by the evaporator and sends the heated outside air or inside air toward the inside of the passenger compartment, in which: a first flow passage is formed through which outside air or inside air flows in the order of the blower fan, the evaporator, the condenser, and the inside of the passenger compartment; a second flow passage is formed which is separated from the first flow passage, and through which inside air flows in the order of the inside air inlet, the heat exchanger, and the outside of the passenger compartment; and the heat exchanger exchanges heat between outside air introduced through the outside air inlet by suction power of the blower fan, and inside air introduced into the second passage after passing, through the first passage and the inside of the passenger compartment by a blowing force of the blower fan, and discharges inside air which has been subjected to heat exchange to the outside of the passenger compartment by using a drain hose provided for discharging drain water to the outside of the passenger compartment, the drain water being generated when outside air is cooled by the evaporator.

### Advantageous Effect of Invention

Power consumption of an air conditioning apparatus can be reduced by sufficiently reducing a temperature difference between the outside air introduced through an outside air inlet and the inside air introduced through an inside air inlet and thereby increasing a heat exchange amount between the inside air and the outside air in a heat exchanger.

### BRIEF DESCRIPTION OF DRAWINGS

FIG. 1 is a diagram illustrating a configuration of a vehicle air conditioning apparatus according to Embodiment 1 of the present invention; and

FIG. 2 is a diagram illustrating a configuration of a vehicle air conditioning apparatus according to Embodiment 2 of the present invention.

### DESCRIPTION OF EMBODIMENTS

Hereinafter, embodiments of the present invention will be described in detail with reference to the drawings.

### Embodiment 1

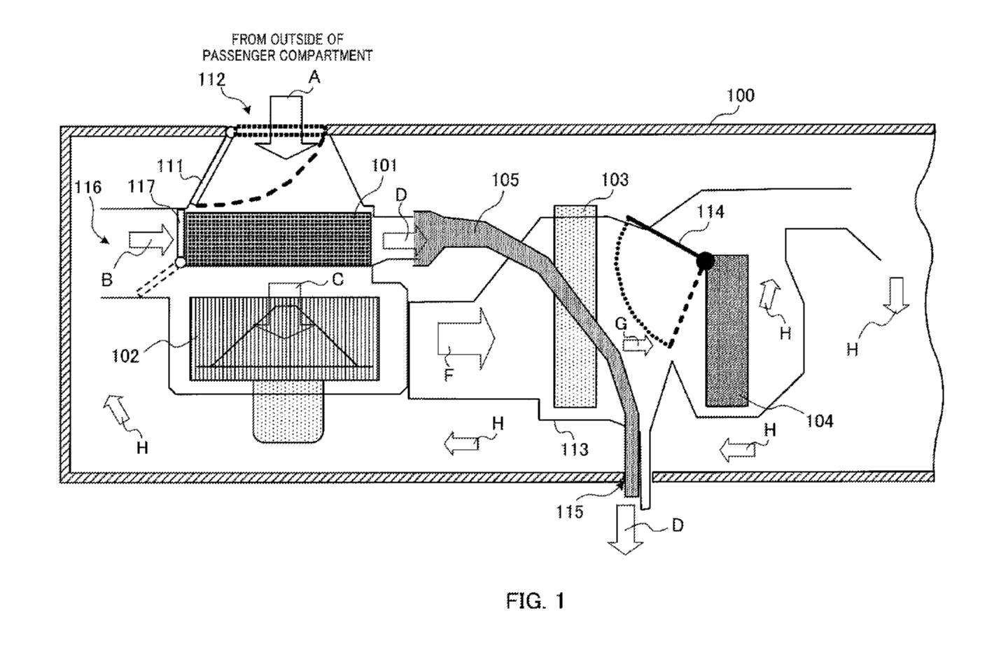

FIG. 1 is a block diagram illustrating a configuration of vehicle air conditioning apparatus 100 according to Embodiment 1 of the present invention. Vehicle air conditioning apparatus 100 is configured to perform heating in a passenger compartment by collecting the heat of outside air, which is a so-called heat pump air conditioning apparatus for vehicles.

Sensible heat exchanger 101 (corresponds to heat exchanger) takes in outside air A from the outside of the passenger compartment through outside air inlet 112 and also takes in inside air B inside the passenger compartment. Sensible heat exchanger 101 exchanges heat between the inside air and outside air, which have been introduced into sensible heat exchanger 101, to make the outside air closer to the temperature inside the passenger compartment. Sensible heat exchanger 101 supplies blower fan 102 with outside air C, which has been subjected to heat exchange, and also discharges inside air D which has been subjected to heat exchange to the outside of the passenger compartment.

Blower fan 102 introduces outside air C, which has been subjected to the heat exchange in sensible heat exchanger 101, into air conditioning duct 113. In addition, blower fan 102 introduces inside air B in the passenger compartment into air conditioning duct 113. Note that, outside air C may be a mixture of air that has passed through sensible heat exchanger 101, and bypassed air that has not passed through sensible heat exchanger 101.

Evaporator 103 cools air F by exchanging heat between air F introduced into air conditioning duct 113 by blower fan 102, and refrigerant. Air F cooled by evaporator 103 is supplied to condenser 104. In this processing, when outside air inlet 112 is opened by door 111 while the flow passage from inside air inlet 116 to blower fan 102 is closed by mix door 117, only the outside air is cooled by evaporator 103. Meanwhile, when outside air inlet 112 is closed by door 111 while the flow passage from inside air inlet 116 to blower fan 102 is opened by mix door 117, only the inside air is cooled by evaporator 103.

Condenser 104 raises the temperature of air G by heat exchange between air G cooled by evaporator 103, and refrigerant. In addition, air H with the temperature raised by condenser 104 is introduced inside the passenger compartment. Air H introduced inside the passenger compartment by condenser 104 becomes inside air B, and the flow rate of inside air B is adjusted by mix door 117, and inside air B is then introduced into at least one of air conditioning duct 113 and sensible heat exchanger 101. Note that, condenser 104 is provided with mix door 114, and some of air G cooled by evaporator 103 is introduced inside the passenger compartment by adjustment of the aperture of mix door 114 without passing through condenser 104.

Discharge hose 105 has one end connected to the outlet for the inside air of sensible heat exchanger 101 and the other end protruding from the passenger compartment through opening 115 provided to vehicle air conditioning apparatus 100. With this configuration, discharge hose 105 discharges the inside air which has been subjected to heat exchange by sensible heat exchanger 101 to the outside of the passenger compartment.

Outside air inlet 112 is provided with door 111. During an outside air introducing operation, door 111 opens and outside air inlet 112 is in communication with the outside of the passenger compartment, which allows outside air A to be taken in the passenger compartment through outside air inlet 112. During an inside air circulating operation, door 111 is closed, which prevents outside air A from being taken in through outside air inlet 112. Note that, the term “outside air introducing operation” refers to a state where cooling and heating is performed in the passenger compartment by using a mixture of outside air and inside air or only outside air, and the term “inside air circulating operation” refers to a state where cooling and heating is performed in the passenger compartment by using only inside air.

Inside air inlet 116 is provided with mix door 117. The degree of mixture between outside air and inside air during the outside air introducing operation is adjustable by adjustment of the aperture of mix door 117. Note that, mix door 117 is closed during the inside air circulating operation (this state of mix door 117 is illustrated with solid line in FIG. 1), so that inside air B is all supplied to air conditioning duct 113 during the inside air circulating operation.

In vehicle air conditioning apparatus 100 having the above described configuration, a first flow passage is formed through which air flows in the order of blower fan 102, evaporator 103, condenser 104, and the inside of the passenger compartment, and a second passage is formed through which air flows in the order of inside air inlet 116, heat exchanger 101, and the outside of the passenger compartment.

As described above, in Embodiment 1, sensible heat exchanger 101 exchanges heat between outside air A not mixed with inside air B, and inside air B. Thus, a temperature difference between outside air A and inside air B can be sufficiently secured, which makes it possible to increase the heat exchange amount between outside air A and inside air B. Accordingly, it is possible to reduce the heat load of the air conditioning apparatus and also to reduce power consumption thereof.

### Embodiment 2

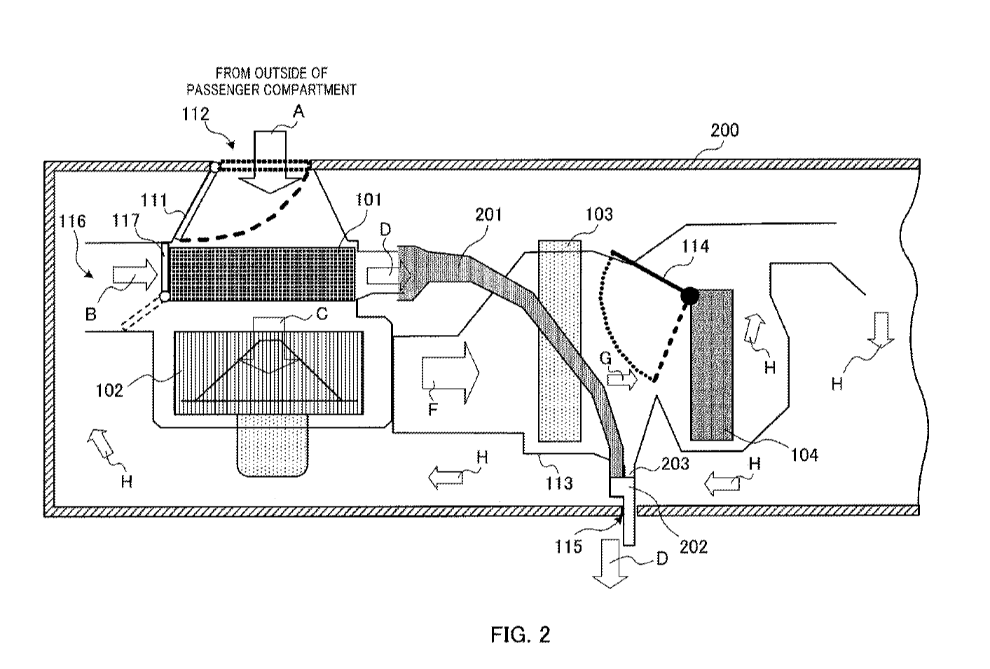

FIG. 2 is a diagram illustrating a configuration of vehicle air conditioning apparatus 200 according to Embodiment 2. In Embodiment 2, inside air D, which has been subjected to heat exchange with outside air by sensible heat exchanger 101, is discharged to the outside of the passenger compartment by using a simple structure.

Vehicle air conditioning apparatus 200 according to Embodiment 2 includes discharge hose 201 in place of discharge hose 105 in vehicle air conditioning apparatus 100 according to Embodiment 1 illustrated in FIG. 1. Note that in FIG. 2, the same reference numerals are used for denoting the same components in FIG. 1, and any duplicate description thereof is omitted.

Discharge hose 201 has one end connected to an outlet for inside air of sensible heat exchanger 101 and the other end connected to drain hose 202. With this configuration, discharge hose 201 discharges the inside air which has been subjected to heat exchange by sensible heat exchanger 101 to the outside of the passenger compartment through drain hose 202. Drain hose 202 is mainly provided for collecting moisture generated during heat exchange between inside air and refrigerant in evaporator 103 and for discharging the moisture to the outside of the passenger compartment.

Drain hose 202 has one end connected to outlet 203 for drain water, which is formed at a bottom part of air conditioning duct 113, and the other end protruding from the passenger compartment through opening 115 provided at a bottom part of vehicle air conditioning apparatus 200. With this configuration, drain hose 202 discharges drain water discharged through outlet 203 and inside air discharged through discharge hose 201 to the outside of the passenger compartment.

As described above, according to Embodiment 2, inside air is discharged from the sensible heat exchanger by using a drain hose provided for discharging drain water to the outside of the passenger compartment. Accordingly, it is not necessary to provide an outlet for discharging inside air to the outside of the passenger compartment in Embodiment 2. Accordingly, in addition to the effects obtained in Embodiment 1, it is possible to obtain a simplified structure of the air conditioning apparatus in Embodiment 2.

Note that, although sensible heat exchanger 101 is provided in Embodiments 1 and 2, the present invention is not limited to this configuration, and a total heat exchanger may be used instead of sensible heat exchanger 101. However, use of a sensible heat exchanger is advantageous in preventing windows from being fogged up in the passenger compartment. This is because, unlike a total heat exchanger, a sensible heat exchanger exchanges only the heat amount and does not exchange latent heat (moisture).

The disclosure of the specification, the drawing, and the abstract of Japanese Patent Application No. 2011-72038, filed on Mar. 29, 2011, is incorporated herein by reference in its entirety.

### Industrial Applicability

The vehicle air conditioning apparatus according to the present invention is favorable as an air conditioning apparatus to be installed in vehicles such as electric vehicles, for example.

### Reference Signs List

100 Vehicle air conditioning apparatus
101 Sensible heat exchanger
102 Blower fan
103 Evaporator
104 Condenser
105 Discharge hose
111, 114, 117, Mix door
112 Outside air inlet
113 Air conditioning duct
115 Opening
116 Inside air inlet

1. A vehicle air conditioning apparatus comprising:
an outside air inlet through which outside air is introduced from outside of a passenger compartment;
an inside air inlet through which inside air is introduced from inside of the passenger compartment;
a heat exchanger that exchanges heat between inside air introduced through the inside air inlet and outside air introduced through the outside air inlet;
a blower fan that blows outside air which has been subjected to heat exchange by the heat exchanger, or outside air introduced through the outside air inlet, or inside air introduced through the inside air inlet;
an evaporator that cools outside air or inside air blown by the blower fan; and
a condenser that heats the outside air or inside air cooled by the evaporator and sends the heated outside air or inside air toward the inside of the passenger compartment, wherein:
a first flow passage is formed through which outside air or inside air flows in the order of the blower fan, the evaporator, the condenser, and the inside of the passenger compartment;
a second flow passage is formed which is separated from the first flow passage, and through which inside air flows in the order of the inside air inlet, the heat exchanger, and the outside of the passenger compartment; and
the heat exchanger exchanges heat between outside air introduced through the outside air inlet by suction power of the blower fan, and inside air introduced into the second passage after passing through the first passage and the inside of the passenger compartment by a blowing force of the blower fan, and discharges inside air which has been subjected to heat exchange to the outside of the passenger compartment by using a drain hose provided for discharging drain water to the outside of the passenger compartment, the drain water being generated when outside air is cooled by the evaporator.

2. The vehicle air conditioning apparatus according to claim 1, wherein the heat exchanger is a sensible heat exchanger.

3. A vehicle comprising the vehicle air conditioning apparatus according to claim 1.
